(19) United States
(12) Patent Application Publication
(10) Pub. No.: US 2015/0220192 A1
(43) Pub. Date: Aug. 6, 2015

(54) LIQUID CRYSTAL DISPLAY DEVICE AND DIGITIZER MODULE FOR THE SAME

(71) Applicant: Samsung Display Co., Ltd., Yongin-city (KR)

(72) Inventors: Ji-Hyeon JEON, Gwangmyeong-si (KR); Yong Woo Lee, Suwon-si (KR)

(21) Appl. No.: 14/454,269

(22) Filed: Aug. 7, 2014

(30) Foreign Application Priority Data
Feb. 5, 2014 (KR) 10-2014-0013245

(51) Int. Cl. G06F 3/041; G02F 1/1333; G06F 3/046

(52) U.S. Cl. CPC G06F 3/0412; G06F 3/046; G02F 1/133308

(57) ABSTRACT

A liquid crystal display that includes a liquid crystal panel configured to display an image, a light guide disposed behind the liquid crystal panel, a light source unit disposed along at least one lateral side of the light guide, the light source unit configured to supply light into the light guide, and a digitizer module disposed on a bottom side of the light guide, the digitizer module including a power wiring electrically connected to the light source unit.

### CROSS-REFERENCE TO RELATED APPLICATION

This application claims priority from and the benefit of Korean Patent Application No. 10-2014-0013245, filed on Feb. 5, 2014, which is hereby incorporated by reference for all purposes as if fully set forth herein.

### BACKGROUND

1. Field

Exemplary embodiments of the present invention relate to a liquid crystal display and a digitizer module. More particularly, Exemplary embodiments of the present invention relate to a digitizer integrated liquid crystal display and a digitizer module for the same.

2. Discussion of the Background

Precise touch control may be realized when a digitizer is installed in a portable liquid crystal display such as a laptop computer, a tablet PC, a smart phone, or a portable multimedia player (PMP). The digitizer is a device for receiving location information instructed by a user on a screen, distinguished from input devices such as a keyboard or a mouse, providing an intuitive and easy user interface.

One type of the digitizer is an electromagnetic resonance (EMR) method. The EMR method uses a digitizer sensor substrate including a plurality of coils, and detects a position of a pen by reading a signal induced to a coil by a magnetic field of the pen when the user moves the pen.

The digitizer is additionally provided and is attached to a rear side of the liquid crystal display. As a result, the liquid crystal display becomes thicker. The increase of thickness of the liquid crystal display due to the digitizer does not follow the recent trend of minimizing the thickness of the liquid crystal display.

A digitizer integrated liquid crystal display may result in a thinner liquid crystal display simplify a process for manufacturing the liquid crystal display.

The above information disclosed in this Background section is only for enhancement of understanding of the background of the invention and therefore it may contain information that does not form the prior art that is already known in this country to a person of ordinary skill in the art.

### SUMMARY

Exemplary embodiments of the present invention provide a digitizer integrated liquid crystal display having a reduced thickness and a simplified manufacturing process, and a digitizer module for the same.

Additional features of the invention will be set forth in the description which follows, and in part will be apparent from the description, or may be learned by practice of the invention.

An exemplary embodiment of the present invention provides a liquid crystal display including: a liquid crystal panel configured to display an image; a light guide disposed behind the liquid crystal panel; a light source unit disposed along at least one lateral side of the light guide, the light source unit configured to supply light into the light guide; and a digitizer module disposed on a bottom side of the light guide, the digitizer module including a power wiring electrically connected to the light source unit.

An exemplary embodiment of the present invention also provides a digitizer module including: an EMR sensor substrate including loop coils; a magnetic sheet disposed on a bottom side of the EMR sensor substrate, the magnetic sheet includes a magnetic material configured to induce an electromagnetic field on the EMR sensor substrate; and a power wiring electrically connected to a light source unit of a backlight assembly.

The thickness of the liquid crystal display with an installed digitizer can be decreased and the manufacturing process can be simplified.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a cross-sectional view of a configuration of a liquid crystal display according to an exemplary embodiment of the present invention.

FIG. 2 shows an exploded perspective view of a liquid crystal display according to an exemplary embodiment of the present invention.

FIG. 3 shows a cross-sectional view of an integrated structure of a backlight assembly and a digitizer module in a liquid crystal display, according to an exemplary embodiment of the present invention.

FIG. 4 shows a top plan view for indicating a wiring structure on an EMR sensor substrate in a liquid crystal display, according to an exemplary embodiment of the present invention.

FIG. 5 shows a cross-sectional view of a structure of a liquid crystal display according to another exemplary embodiment of the present invention.

FIG. 6 shows an exploded perspective view of a liquid crystal display according to another exemplary embodiment of the present invention.

FIG. 7 shows a cross-sectional view of an integrated structure of a backlight assembly and a digitizer module in a liquid crystal display, according to another exemplary embodiment of the present invention.

### DETAILED DESCRIPTION OF THE ILLUSTRATED EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Further, in exemplary embodiments, since like reference numerals designate like elements having the same configuration, a first exemplary embodiment is representatively described, and in other exemplary embodiments, only a configuration different from the first exemplary embodiment will be described.

Parts that are irrelevant to the description may be omitted to clearly describe the present invention, and the same elements may be designated by the same reference numerals throughout the specification.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present. It will be understood that when an element such as a layer, film, region, or substrate is referred to as being “on” another element, it can be directly on the other element or intervening elements may also be present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

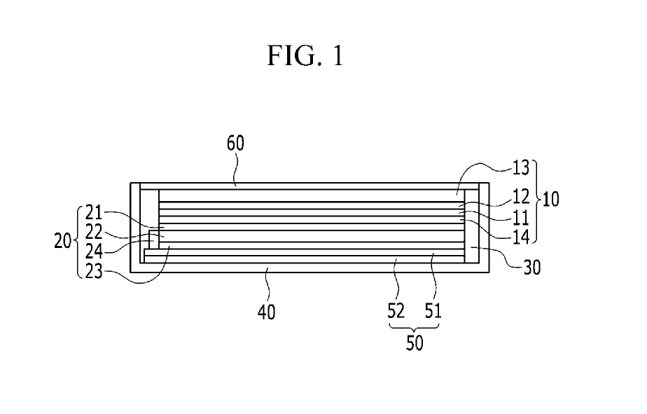

A digitizer integrated liquid crystal display according to an exemplary embodiment will now be described with reference to FIGS. 1, 2, 3, and 4.

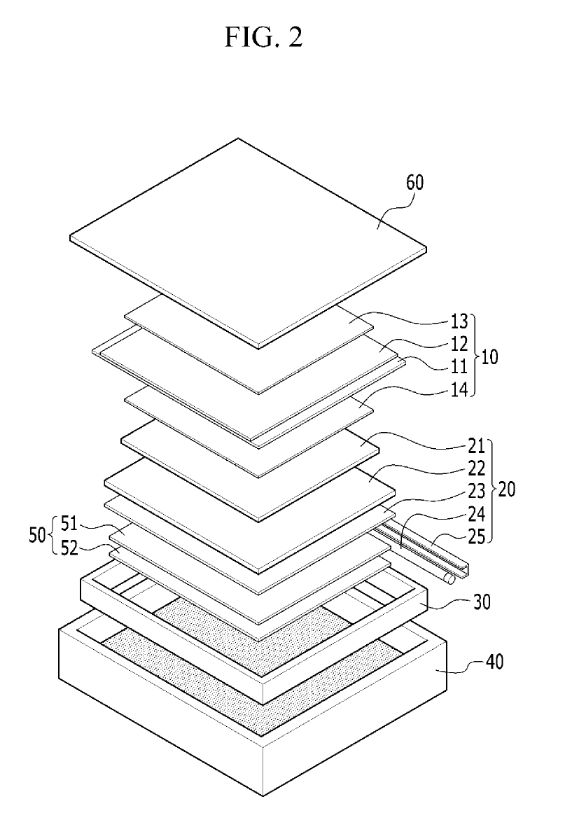

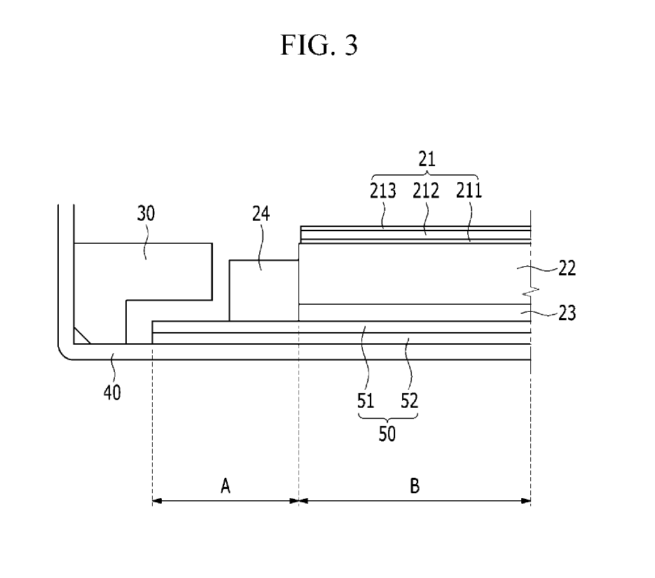

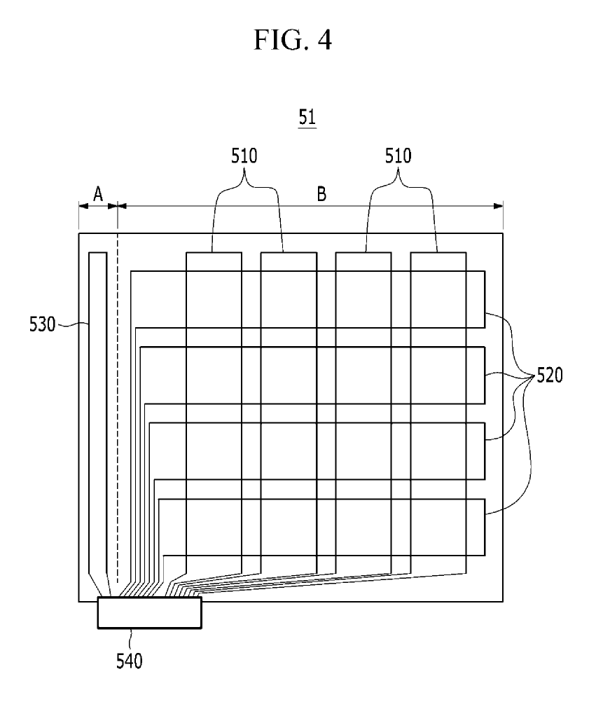

FIG. 1 shows a cross-sectional view of a configuration of a liquid crystal display according to an exemplary embodiment of the present invention. FIG. 2 shows an exploded perspective view of the liquid crystal display of FIG. 1, according to an exemplary embodiment of the present invention. FIG. 3 shows a cross-sectional view of an integrated structure of a backlight assembly and a digitizer module in the liquid crystal display. FIG. 4 shows a top plan view for indicating a wiring structure on an EMR sensor substrate in the liquid crystal display, according to an exemplary embodiment of the present invention.

Referring to FIGS. 1, 2, 3, and 4, the liquid crystal display includes a liquid crystal panel 10, a touch screen panel 60 disposed on an upper side of the liquid crystal panel 10, a backlight assembly 20 disposed on a bottom side of the liquid crystal panel 10, and a digitizer module 50 disposed on the bottom side of the liquid crystal panel 10. The liquid crystal display may further include a mold frame 30 disposed surrounding lateral sides of the touch screen panel 60, the liquid crystal panel 10, the backlight assembly 20, and the digitizer module 50. The liquid crystal display may further include a bottom chassis 40 for wrapping an external lateral side of the mold frame 30 and supporting and wrapping lower sides of the mold frame 30 and the digitizer module 50.

The liquid crystal panel 10 includes a thin film transistor substrate 11 and a color filter substrate 12 facing each other, a liquid crystal layer (not shown) provided between the thin film transistor substrate 11 and the color filter substrate 12, a first polarizer 13 provided between the color filter substrate 12 and the touch screen panel 60, and a second polarizer 14 provided between the thin film transistor substrate 11 and the backlight assembly 20. A plurality of liquid crystal cells configuring pixel units are arranged in a matrix form, and the liquid crystal panel 10 displays an image by controlling light transmittance of the liquid crystal cells according to an image signal.

A plurality of gate lines and a plurality of data lines are disposed in a matrix on the thin film transistor substrate 11, and thin film transistors (TFTs) are formed between the gate lines and the data lines. A pixel electrode is connected to each thin film transistor, and a data voltage is applied to the pixel electrode through the corresponding thin film transistor.

A color filter for expressing the transmitted light with a predetermined color is disposed on the color filter substrate 12. A common electrode facing the pixel electrode may be disposed on the color filter substrate 12. A common voltage is applied to the common electrode, and an electric field is generated between the pixel electrode and the common electrode. Liquid crystal molecules of the liquid crystal layer are arranged according to the electric field to control light transmittance.

The color filter substrate 12 may be smaller than the thin film transistor substrate 11, including a display area of the liquid crystal panel 10 where the color filter substrate 12 overlaps the thin film transistor substrate 11, and a non-display area adjacent to the display area where the color filter substrate 12 does not overlap the thin film transistor substrate 11.

The first polarizer 13 and the second polarizer 14 may have polarizing directions substantially perpendicular to each other. The second polarizer 14 polarizes the light incident to the liquid crystal panel 10, and the first polarizer 13 may operate as an analyzer.

The backlight assembly 20 includes a light guide 22 disposed in parallel with a bottom side of the liquid crystal panel 10, a light source unit 24 disposed along at least one lateral side of the light guide 22 and configured to supply light to the light guide 22, a light source reflector 25 for receiving the light source unit 24 and reflecting the light radiated by the light source unit 24 to the light guide 22, an optical sheet 21 disposed on an upper side of the light guide 22 configured to diffuse and gather the light incident to the liquid crystal panel 10, and a reflection sheet 23 disposed on a bottom side of the light guide 22.

The light guide 22 includes an input side to which light enters from the light source unit 24, an output side that is orthogonal to the input side and is parallel to the liquid crystal panel 10, and a bottom side on which a pattern is formed so that the input light may proceed towards the output side. The light guide 22 changes the light input from the light source unit 24 into planar light to be uniformly radiated to the liquid crystal panel 10 through the output side. Polymethylmethacrylate (PMMA) having excellent transmittance and strength may be used for the light guide 22.

The optical sheet 21 may include a diffuser sheet 211, a prism sheet 212, and a protecting sheet 213. The diffuser sheet 211 diffuses light and improves uniformity of light to decrease spot generated on the liquid crystal panel 10 from partial concentration of the light radiated to the liquid crystal panel 10 from the light guide 22. The prism sheet 212 improves luminance by controlling the light passing through the diffuser sheet 211 to have a vertical direction. The protecting sheet 213 protects the diffuser sheet 211 and the prism sheet 212, and decreases damage from external impacts and inflow of foreign particles. The optical sheet 21 may also include various kinds of optical sheets in addition to the diffuser sheet 211, the prism sheet 212, and the protecting sheet 213.

The reflection sheet 23 reflects the light, leaking in a direction away from the liquid crystal panel 10, back to the direction towards the light guide 22. The use of the reflection sheet 23 reduces light loss and improves uniformity of light transmitted in the direction of the liquid crystal panel 10.

The digitizer module 50 includes an electromagnetic resonance (EMR) sensor substrate 51 and a magnetic sheet 52 disposed on a bottom side of the EMR sensor substrate 51. A plurality of loop coils is arranged on the EMR sensor substrate 51. For example, a plurality of rectangular loop coils may be arranged in one direction, and a plurality of loop coils in the same form may be arranged in the orthogonal direction on the EMR sensor substrate 51. The magnetic sheet 52 is configured with a magnetic material for inducing formation of an electromagnetic field of the EMR sensor substrate 51. The magnetic sheet 52 may be about 25 μm thick, and may be made of an amorphous metal having an excellent magnetic property. The EMR sensor substrate 51 may be provided to be a flexible printed circuit board (FPCB).

The digitizer module 50 is disposed on a bottom side of the light guide 22 of the backlight assembly 20 and is formed to be wider than the light guide 22. Regarding the digitizer module 50, a plurality of loop coils are disposed in a region (B) overlapping the light guide 22, and power wiring for the light source unit 24 of the backlight assembly 20 is disposed in a region (A) not overlapping the light guide 22. The light source unit 24 is installed in the region (A) in which the power wiring of the digitizer module 50 is disposed. That is, the light source unit 24 and the digitizer module 50 may be disposed on the FPCB. Accordingly, since an additional FPCB for the light source unit 24 is not needed, a number of components of the liquid crystal display may be reduced, the manufacturing process may be simplified, and the thickness of the liquid crystal display may be reduced.

The region (B) overlapping the light guide 22 in the digitizer module 50 may correspond to the display area. The region (A) not overlapping the light guide 22 in the digitizer module 50 may correspond to the non-display area.

The mold frame 30 surrounds lateral sides of the liquid crystal panel 10, the backlight assembly 20, and the digitizer module 50, and upper and lower sides of the mold frame 30 include opening. The mold frame 30 may also have a space for receiving the light source unit 24 and the light source reflector 25 on one lateral side of the mold frame 30.

The bottom chassis 40 supports the liquid crystal panel 10, the backlight assembly 20, the digitizer module 50, and the mold frame 30, and the bottom chassis 40 is formed to wrap the lateral side of the mold frame 30 and the entire lower sides of the digitizer module 50 and the mold frame 30. The bottom chassis 40 may be formed with at least one of a non-magnetic metal such as magnesium and aluminum and non-magnetic steel use stainless (SUS) steel.

Referring to FIG. 4, the EMR sensor substrate 51 includes a first loop coil 510, a second loop coil 520, power wiring 530, and a connector 540.

The first loop coil 510 and the second loop coil 520 are disposed in the region (B) of the EMR sensor substrate 51 overlapping the light guide 22. The power wiring 530 is disposed in the region (A) of the EMR sensor substrate 51 not overlapping the light guide 22.

The first loop coil 510 is disposed in a quadrangle shape and extending lengthwise in a first direction. The second loop coil 520 is disposed is a quadrangle shape and extending lengthwise in a second direction substantially perpendicular to the first direction. The first loop coil 510 is disposed to overlap the second loop coil 520. One of the first loop coil 510 and the second loop coil 520 may become a driving channel for forming a magnetic field, and the other thereof may become a receiving channel for detecting a touch position.

The first loop coil 510 may be disposed on the first electrode layer, and the second loop coil 520 may be disposed on the second electrode layer disposed on the first electrode. A first insulating layer is formed between the first electrode layer and the second electrode layer, and the first loop coil 510 is electrically insulated from the second loop coil 520. A second insulating layer may be disposed on the second electrode layer. The power wiring 530 may be disposed on the second insulating layer. Power may be supplied to the light source unit 24 by installing the light source unit 24 in the region in which the power wiring 530 is disposed.

The first loop coil 510, the second loop coil 520, and the power wiring 530 may be formed with a metal material, such as copper (Cu), aluminum (Al), molybdenum (Mo), and/or silver (Ag). The EMR sensor substrate 51 has substantially no effect on the transmittance of the liquid crystal panel 10. Therefore, exemplary embodiments of present invention may include any line width, thickness, and position of the first loop coil 510, the second loop coil 520, and the power wiring 530, thereby providing freedom to design an EMR with a low resistance.

The first loop coil 510, the second loop coil 520, and the power wiring 530 are connected to the connector 540. The connector 540 provides an external interface to the first loop coil 510, the second loop coil 520, and the power wiring 530. The first loop coil 510 and the second loop coil 520 may be connected to an EMR IC (not shown) for controlling an operation of the digitizer module 50 through the connector 540. The power wiring 530 may be connected to a power IC for controlling an operation of the light source unit 24.

As described above, the power wiring for the light source unit 24 of the backlight assembly 20 is disposed on a part of an edge of one lateral side of the digitizer module 50, so the light source unit 24 may be mounted to the digitizer module 50, and no additional FPCB for the light source unit 24 is needed.

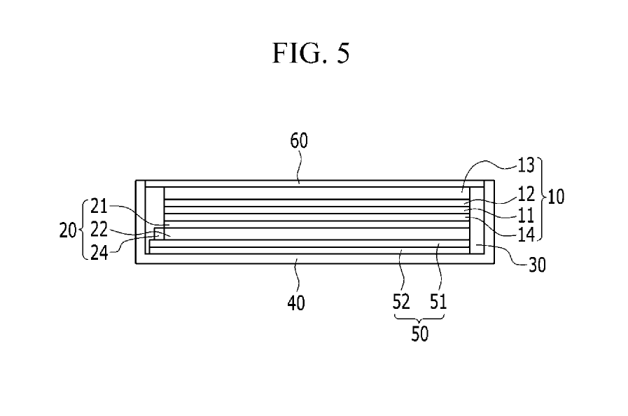

A digitizer integrated liquid crystal display according to another exemplary embodiment will now be described with reference to FIGS. 5, 6, and 7.

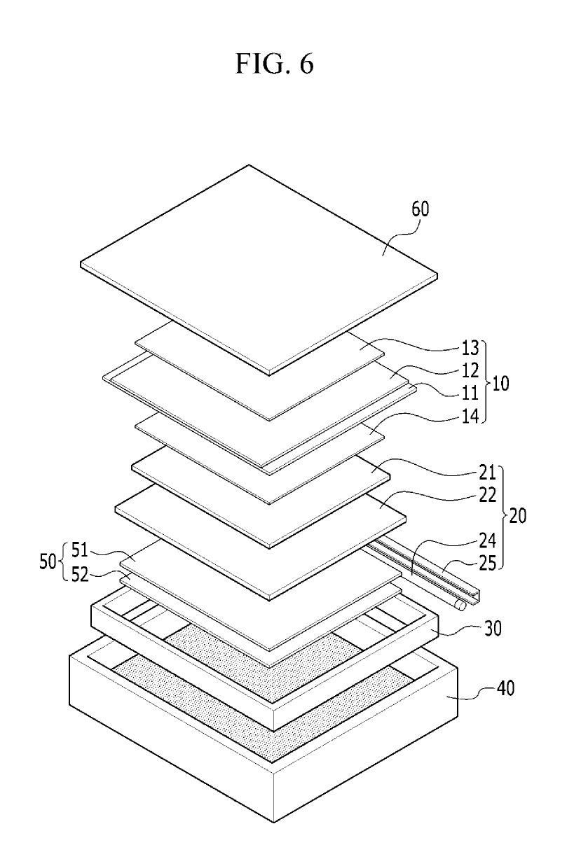

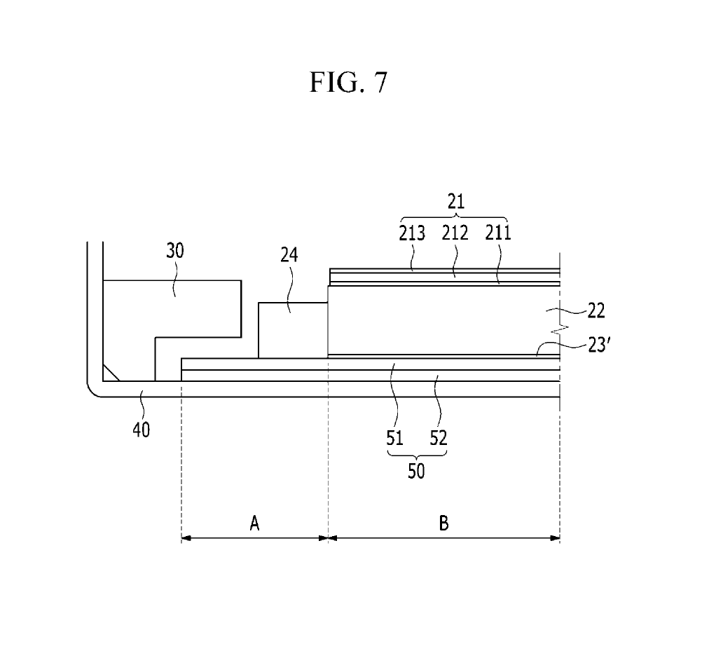

FIG. 5 shows a cross-sectional view of a structure of a liquid crystal display according to an exemplary embodiment of the present invention. FIG. 6 shows an exploded perspective view of a liquid crystal display according to an exemplary embodiment of the present invention. FIG. 7 shows a cross-sectional view of an integrated structure of a backlight assembly and a digitizer module in a liquid crystal display according to an exemplary embodiment of the present invention.

Regarding the difference with the liquid crystal display described with reference to FIGS. 1, 2, 3, and 4, the front of the digitizer module 50 is coated with a reflection coating layer 23′, and the reflection sheet 23 disposed on the bottom side of the light guide 22 may be omitted. Various coating materials for reflecting white light may be used for the reflection coating layer 23′. For example, the coating material of the reflection coating layer 23′ may be ZrO₂, SiO₂, or Al₂O₃. The reflection coating layer 23′ may be coated in the region (B), in which the digitizer module 50 overlaps the light guide 22. The reflection coating layer 23′ may also be coated in the region (A) as well as the region (B), and in this case, the power wiring for the light source unit 24 may be formed on the reflection coating layer 23′.

Other configurations except the reflection coating layer 23′ correspond to those that are described with reference to FIGS. 1, 2, 3, and 4, so no detailed description will be provided.

Accordingly, the digitizer module 50 may include the function of the reflection sheet 23, and the digitizer module 50 and the backlight assembly 20 may be configured in a unified manner by forming the reflection coating layer 23′ on the surface of the digitizer module 50.

The accompanying drawings and the detailed description of the present invention are illustrated by way of example, and are not used to limit the meaning or limit the scope of the present invention described in claims but are used to describe the present invention. Therefore, it will be appreciated to those skilled in the art that various modifications are made and other equivalent embodiments are available. Therefore, a true technical scope of the present invention will be defined by the technical spirit of the appended claims.

What is claimed is:

1. A liquid crystal display comprising:
a liquid crystal panel configured to display an image;
a light guide disposed behind the liquid crystal panel;
a light source unit disposed along at least one lateral side of the light guide, the light source unit configured to supply light into the light guide; and
a digitizer module disposed on a bottom side of the light guide, the digitizer module comprising a power wiring electrically connected to the light source unit.

2. The liquid crystal display of claim 1, wherein the digitizer module is wider than the light guide.

3. The liquid crystal display of claim 2, wherein:
the digitizer module comprises a first region overlapping the light guide and a second region not overlapping the light guide;
the power wiring is disposed in the second region; and
the light source unit is disposed in the second region.

4. The liquid crystal display of claim 1, further comprising an optical sheet disposed between the liquid crystal panel and the light guide.

5. The liquid crystal display of claim 1, further comprising a reflection sheet disposed between the light guide and the digitizer module.

6. The liquid crystal display of claim 4, further comprising a reflection coating layer disposed on the upper side of the digitizer module, the reflecting coating layer being configured to reflect white light.

7. The liquid crystal display of claim 1, wherein the digitizer module comprises:
an EMR sensor substrate comprising loop coils; and
a magnetic sheet disposed on the bottom side of the EMR sensor substrate, the magnetic sheet comprising a magnetic material configured to induce an electromagnetic field on the EMR sensor substrate.

8. The liquid crystal display of claim 7, wherein the loop coils comprise:
a first loop coil disposed in a quadrangle shape and extending lengthwise in a first direction; and
a second loop coil disposed in a quadrangle shape and extending lengthwise in a second direction that is substantially perpendicular to the first direction, and
the power wiring is disposed on the EMR sensor substrate.

9. The liquid crystal display of claim 8, wherein the first loop coil and the second loop coil are disposed in a first region of the EMR sensor substrate overlapping the light guide,
the power wiring is disposed in a second region of the EMR sensor substrate not overlapping the light guide, and
the light source unit is mounted in the second region of the EMR sensor substrate.

10. The liquid crystal display of claim 8, wherein the EMR sensor substrate is a flexible printed circuit board (FPCB).

11. The liquid crystal display of claim 8, wherein the EMR sensor substrate further comprises a connector configured to provide an external interface to the first loop coil, the second loop coil, and the power wiring.

12. A digitizer module comprising:
an EMR sensor substrate comprising loop coils;
a magnetic sheet disposed on a bottom side of the EMR sensor substrate, the magnetic sheet comprising a magnetic material configured to induce an electromagnetic field on the EMR sensor substrate; and
a power wiring electrically connected to a light source unit of a backlight assembly.

13. The digitizer module of claim 12, further comprising a light guide disposed on the EMR sensor substrate.

14. The digitizer module of claim 13, wherein the EMR sensor substrate is wider than the light guide.

15. The digitizer module of claim 14, wherein:
the EMR sensor substrate comprises a first region overlapping the light guide and a second region not overlapping the light guide;
the power wiring is disposed in the second region; and
the light source unit is disposed in the second region.

16. The digitizer module of claim 15, further comprising a reflection sheet disposed between the light guide and the EMR sensor substrate.

17. The digitizer module of claim 15, further comprising a reflection coating layer disposed on an upper side of the EMR sensor substrate, the reflecting coating layer being configured to reflect white light.

18. The digitizer module of claim 15, wherein the loop coils comprise:
a first loop coil disposed in a quadrangle shape and extending lengthwise in a first direction; and
a second loop coil disposed in a quadrangle shape and extending lengthwise in a second direction that is substantially perpendicular to the first direction, and
wherein the first loop coil and the second loop coil are disposed in the first region.

19. The digitizer module of claim 18, wherein the EMR sensor substrate further comprises a connector configured to provide an external interface to the first loop coil, the second loop coil, and the power wiring.

20. The digitizer module of claim 18, wherein the EMR sensor substrate is an FPCB.
